(19) United States
(12) Patent Application Publication
(10) Pub. No.: US 2026/0228658 A1
(43) Pub. Date: Aug. 6, 2026

(54) WORK PLAN OPTIMIZATION DEVICE, METHOD, AND PROGRAM

(71) Applicants: NEC CORPORATION, Tokyo (JP); NEC PLATFORMS, LTD., Kanagawa (JP)

(72) Inventors: Hiroshi CHISHIMA, Tokyo (JP); Masayo KAIDA, Kanagawa (JP)

(73) Assignees: NEC CORPORATION, Tokyo (JP); NEC PLATFORMS, LTD., Kanagawa (JP)

(21) Appl. No.: 19/154,460

(22) PCT Filed: Jan. 17, 2024
(86) PCT No.: PCT/JP2024/001100

§ 371 Date: Aug. 7, 2025

(30) Foreign Application Priority Data
Feb. 15, 2023 (JP) 2023-021319

(51) Int. Cl. G06Q 10/0631

(52) U.S. Cl. CPC G06Q 10/063118

(57) ABSTRACT

The work plan optimization device 80 optimizes a plan to assign each task in a plurality of work processes to a target worker. The task selection optimization unit 81 optimizes, while advancing time to assign tasks in the work processes, a selection of tasks to be prioritized at each time based on skills and number of the workers. The assignment optimization unit 82 optimizes the workers to be assigned, in consideration of constraints of the workers, for the optimized selection of the tasks. The output unit 83 outputs a schedule of tasks assigned to the workers as a work plan.

### TECHNICAL FIELD

The present invention relates to a work plan optimization device, a work plan optimization method, and a work plan optimization program for optimizing a work plan that assigns workers to tasks in a plurality of work processes.

### BACKGROUND ART

In practice, the assignment of workers to individual tasks is routinely performed. Common assignment approaches include simply assigning tasks in the order they occur, or relying on experienced managers to assign tasks based on their intuition and experience. However, such methods tend to be highly dependent on individual judgment, and frequently result in inefficiencies, imbalance, and losses when compared to an ideal assignment.

Furthermore, in conventional approaches, managers often require tens of minutes to formulate a plan, and if an event occurs that necessitates a change to the plan, they must again spend significant time to reconstruct it. Additional problems include degraded plan quality when skilled managers are unavailable, and the difficulty of training such experienced managers. Consequently, various computer-based methods for generating efficient work plans with reduced dependence on individual skill have been proposed.

Patent Literature 1 discloses a production system planning method that generates an optimized production system. In the method described in Patent Literature 1, a process plan is created by defining the order of operations for processing and assembling products and assigning equipment to each operation. Based on the process plan and equipment layout plan, a worker assignment plan is then formulated. Finally, a production plan is generated by scheduling production resources so as to fulfill the production requirements of the production system based on the content of the process plan, equipment layout plan, and worker assignment plan.

### CITATION LIST

### Patent Literature

Patent Literature 1: JP 2003-162313 A

### SUMMARY OF INVENTION

### Technical Problem

The method described in Patent Literature 1 selects workers to assign to each operation under the assumption that suitable workers exist for every work process. Accordingly, at the time when the process plan or equipment layout plan is created as per Patent Literature 1, constraints on the assignable workers are not taken into account. This may result in infeasible task schedules.

Furthermore, the problem of work plan generation—namely, optimizing both the task schedule and the assignment of workers to the schedule—is mathematically an NP-hard problem. Therefore, it is computationally difficult to solve using simple algorithms, making it challenging to automate with computers. While the method of Patent Literature 1 can generate a production plan that meets production requirements, it does not necessarily produce an optimal plan.

Therefore, an example object of the present invention is to provide a work plan optimization device, a work plan optimization method, and a work plan optimization program that can optimize a work plan that assigns workers in consideration of worker constraints.

### Solution to Problem

A work plan optimization device according to the present invention is a work plan optimization device that optimizes a plan to assign each task in a plurality of work processes to a target worker, the device include: a task selection optimization unit that optimizes, while advancing time to assign tasks in the work processes, a selection of tasks to be prioritized at each time based on skills and number of the workers; an assignment optimization unit that optimizes the workers to be assigned, in consideration of constraints of the workers, for the optimized selection of the tasks; and an output unit that outputs a schedule of tasks assigned to the workers as a work plan.

A work plan optimization method according to the present invention is a method for optimizing a plan to assign each task in a plurality of work processes to a target worker, the method includes: optimizing, while advancing time to assign tasks in the work processes, a selection of tasks to be prioritized at each time based on the skills and number of the workers; optimizing the workers to be assigned in consideration of constraints of the workers for the optimized selection of the tasks; and outputting a schedule of tasks assigned to the workers as a work plan.

A work plan optimization program according to the present invention is a work plan optimization program applied to a computer that optimizes a plan to assign each task in a plurality of work processes to a target worker, the program causing the computer to execute: a task schedule optimization process that optimizes a selection of tasks to be prioritized at each time based on skills and number of the workers while advancing time to assign tasks in the work processes; an assignment optimization process that optimizes the workers to be assigned in consideration of constraints of the workers for the optimized selection of the tasks; and an output process that outputs a schedule of tasks assigned to the workers as a work plan.

### Advantageous Effects of Invention

According to the present invention, it is possible to optimize a work plan that assigns workers in consideration of worker constraints.

### BRIEF DESCRIPTION OF DRAWINGS

FIG. 1 It depicts a block diagram illustrating an example embodiment of a work plan optimization device according to the present invention.

FIG. 2 It depicts an explanatory diagram showing an example of work schedule data.

FIG. 3 It depicts an explanatory diagram showing an example of information stored in a worker database.

FIG. 4 It depicts an explanatory diagram showing an example of information stored in a work location distance database.

FIG. 5 It depicts an explanatory diagram illustrating a specific example of a task selection optimization process.

FIG. 6 It depicts a flowchart illustrating an example operation of the work plan optimization device.

FIG. 7 It depicts an explanatory diagram showing an example of visualized work schedule data.

FIG. 8 It depicts an explanatory diagram showing an example of visualized selected tasks.

FIG. 9 It depicts an explanatory diagram showing an example of a schedule with assigned workers.

FIG. 10 It depicts a flowchart illustrating an example of a task selection optimization process.

FIG. 11 It depicts a flowchart illustrating an example of a worker assignment optimization process.

FIG. 12 It depicts a block diagram illustrating an overview of a work plan optimization device according to the present invention.

### EXAMPLE EMBODIMENT

Hereinafter, an example embodiment of the present invention will be described with reference to the drawings. In the following example embodiment, an optimal work plan for workers is generated for various tasks occurring simultaneously in multiple work processes, such as production lines, using a combinatorial optimization solver including quantum annealing techniques. In this example embodiment, it is assumed that the order of tasks occurring on the same line does not change. Furthermore, it is assumed that each worker has a known skill set, and workers who possess the skills required to perform a given task are assigned to that task.

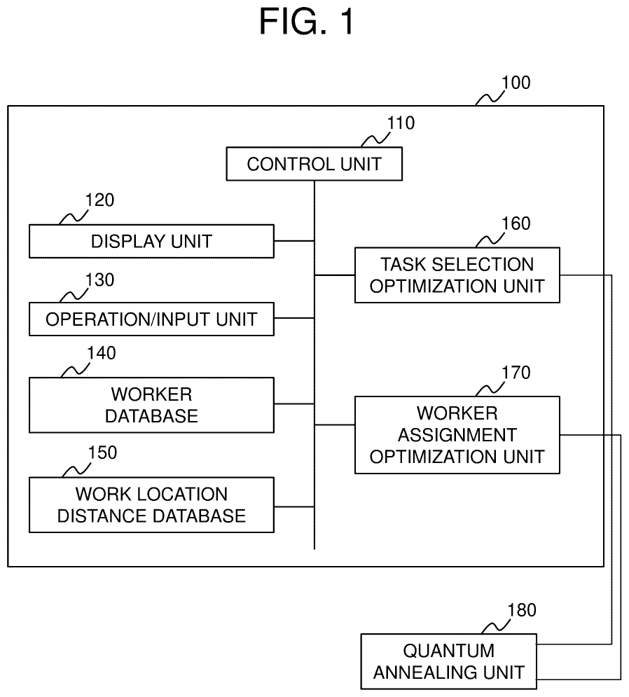

FIG. 1 is a block diagram illustrating an example embodiment of a work plan optimization device according to the present invention. A work plan optimization device 100 of this example embodiment includes a control unit 110, a display unit 120, an operation/input unit 130, a worker database 140, a work location distance database 150, a task selection optimization unit 160, and a worker assignment optimization unit 170.

The work plan optimization device 100 is a device for optimizing a plan to assign each task in a plurality of work processes to a target worker and is implemented as a typical computer system. Examples of work processes include, for instance, production lines in a factory.

The work plan optimization device 100 is communicably connected to a quantum annealing unit 180. Note that the work plan optimization device 100 may be configured to include the quantum annealing unit 180.

The quantum annealing unit 180 is a dedicated device for obtaining the ground state of a Hamiltonian in an Ising model and executes annealing based on an Ising model generated by the task selection optimization unit 160 and the worker assignment optimization unit 170, which will be described later.

More specifically, a quantum annealing machine is a device that probabilistically determines the values of binary variables that minimize or maximize an objective function (that is, a Hamiltonian) of an Ising model, where the binary variables are the arguments. The binary variables may be implemented using classical bits or quantum bits. Note that the configuration of the quantum annealing unit 180 in the present example embodiment is not limited. The quantum annealing unit 180 may be composed of any hardware that probabilistically obtains the values of binary variables minimizing or maximizing an objective function defined using binary variables. For example, the quantum annealing unit 180 may be a non-von Neumann computer in which the objective function is implemented in the form of an Ising model by hardware. Alternatively, the quantum annealing unit 180 may be a device that performs pseudo-quantum annealing or quantum-inspired processing.

Note that if the task selection optimization unit 160 and the worker assignment optimization unit 170 described later do not use quantum annealing for optimization processing, the quantum annealing unit 180 need not be connected to the work plan optimization device 100. The control unit 110 is a unit that controls various processes executed by the work plan optimization device 100.

The display unit 120 displays the progress and results of processing performed by the work plan optimization device 100. The display unit 120 is implemented by a display device, for example.

The operation/input unit 130 accepts various operation instructions for the work plan optimization device 100. The operation/input unit 130 also accepts input of information necessary for various processes executed by the work plan optimization device 100. In this example embodiment, the operation/input unit 130 accepts input of work schedule data for the allocation period (e.g., one day).

The work schedule data includes work data (e.g., work content, work location, occurrence time, work duration), information about workers to be assigned during the allocation period (e.g., on-duty workers), and information about lines during the allocation period.

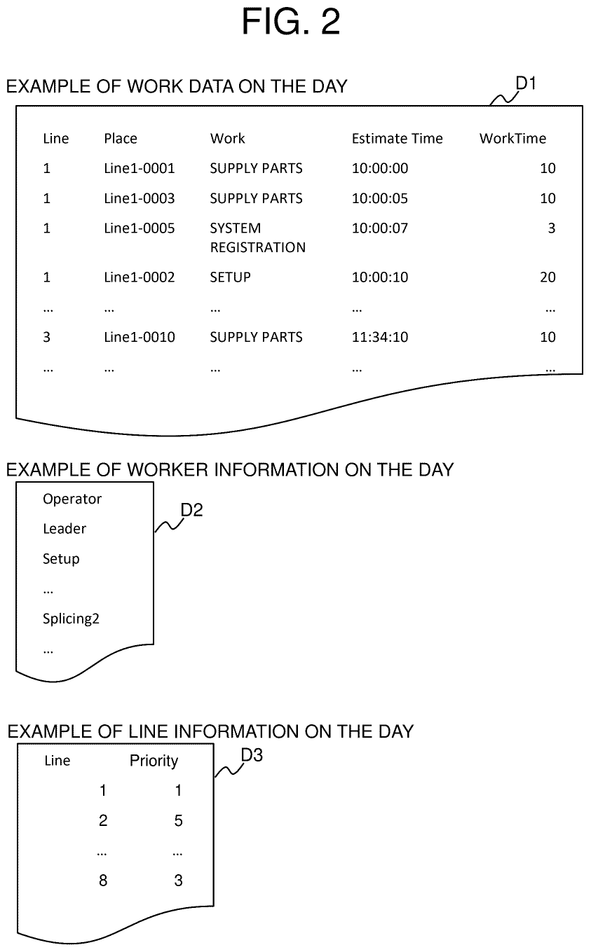

FIG. 2 is an explanatory diagram showing an example of work schedule data. In FIG. 2, data D1 represents the work data on the day, data D2 represents the worker information on the day, and data D3 represents the line information on the day.

Specifically, “Line” in data D1 identifies the work line indicating the work process, “Place” indicates the work location, “Work” indicates the work content, “Estimate Time” indicates the estimated occurrence time, and “Work Time” indicates the work duration. The work content corresponds to the skills of the workers.

Data D2 lists the workers on duty that day, allowing the number of workers to be identified. In data D3, “Priority” indicates the priority of the work process (line), where smaller numbers represent higher priority. The line priority is preset, for example, based on loss.

The worker database 140 acquires various information for the workers to be assigned. In this example embodiment, the worker database 140 stores the skills held and the priority of work processes for each worker. The priority is preset based on the worker's strengths/weaknesses for specific tasks and other duties and the like. The worker database 140 is implemented by, for example, a magnetic disk device and has a function to extract and return necessary data in response to queries and the like.

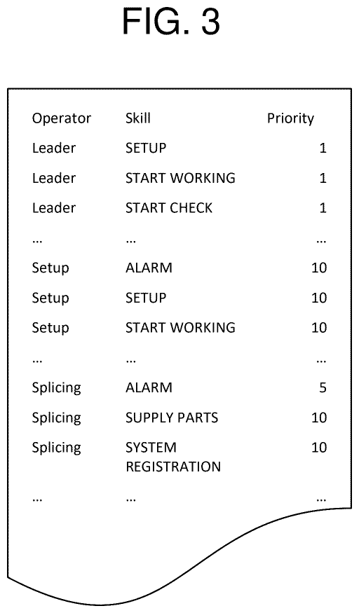

FIG. 3 is an explanatory diagram showing an example of information stored in the worker database 140. In the example shown in FIG. 3, the skills (Skill) held by each worker (Operator) and the priority (Priority) of the work process of the worker are associated with each other and held.

The work location distance database 150 stores information indicating distances between work locations. In a production line, which is an example of a work process, the distance between work locations means the distance between one task location and another task location. The work location distance database 150 is also implemented by, for example, a magnetic disk device and has a function to extract and return necessary data in response to queries and the like.

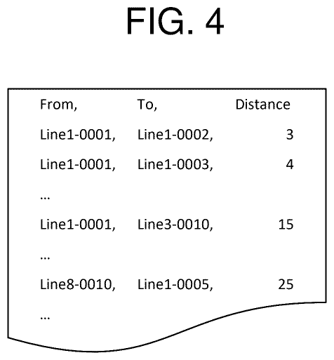

FIG. 4 is an explanatory diagram showing an example of information stored in the work location distance database 150. The example shown in FIG. 4 shows an example in which distances (Distance) to two work locations are associated with each other.

The task selection optimization unit 160 optimizes the selection of tasks to be prioritized. In this example embodiment, since the worker assignment optimization unit 170, which will be described later, performs optimization in consideration of worker constraints, the task selection optimization unit 160 only determines whether assignment is possible based on the number and skills of the workers.

Specifically, the task selection optimization unit 160 optimizes the selection of tasks to be prioritized at each time while advancing the time t to assign tasks in the work process at predetermined intervals, based on the skills and the number of the workers. In other words, the task selection optimization unit 160 focuses on the moment at time t and optimizes the selection of tasks at that time.

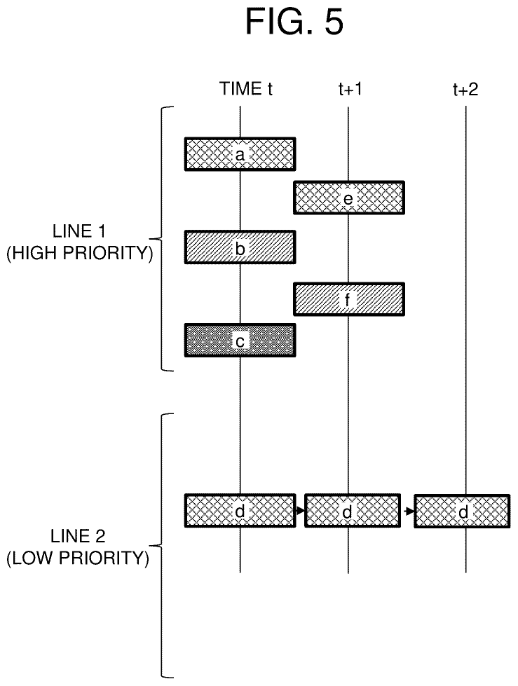

FIG. 5 is an explanatory diagram illustrating a specific example of a task selection optimization process. In the example shown in FIG. 5, it is assumed that there are three workers to be assigned, each having the following skills: {Skill A, Skill B}, {Skill B, Skill C}, and {Skill C}. The rectangular shapes illustrated in FIG. 5 represent the tasks a to f to be assigned. Here, tasks a, d, and e require Skill A; tasks b and f require Skill B; and task c requires Skill C. Furthermore, Line 1, where tasks a, b, c, e, and f are to be performed, is assumed to be a high-priority line, whereas the line where task d is to be performed is assumed to be a low-priority line.

Focusing on time t, tasks a, b, c, and d are available for assignment. Since only one task can be assigned to each of the three workers, not all tasks can be assigned. As a result of optimization (where tasks on the higher priority line are selected), the lower-priority task d is deferred (i.e., considered for assignment at time t+1).

Next, at time t+1, tasks d, e, and f are available for assignment. Although there are three tasks and three workers, only one worker has the necessary Skill A. As a result of optimization (where tasks on the higher priority line are selected), the lower-priority task d is again deferred (i.e., considered for assignment at time t+2).

Next, at time t+2, only task d is available for assignment. Since there is a worker with Skill A, task d is selected at time t+2. Note that the actual assignment of workers is not performed at this stage, as it is necessary to consider the overall time balance.

The objective function used in the optimization by the task selection optimization unit 160 is determined according to the optimization method. For example, if optimization is performed using quantum annealing, an Ising model may be used as the objective function. The following explanation provides an example where optimization is performed using quantum annealing. However, the optimization method is not limited to quantum annealing and may be performed using a mathematical optimization solver.

The objective function used for optimizing task selection at time t (hereinafter also referred to as the “optimization model”) may be expressed, for example, by Equation 1 below. In Equation 1, x_{w,wr} is a binary variable indicating whether worker wr executes task w; a value of 1 indicates that the task is executed, and a value of 0 indicates that it is not. Also, cost_{w} represents the loss incurred when task w is not selected. Since cost_{w} can be considered equivalent to task priority, for example, the “Priority” in data D3 illustrated in FIG. 2 may be used as cost_{w}. In other words, the task selection optimization unit 160 may optimize task selection based on the priority of the work process.

$$[ Math . 1 ]$$

$$minimize {\sum }_{w} ( 1 - {\sum }_{w r} {x}_{w , w r} ) * {cost}_{w} \qquad ( Equation 1 )$$

Furthermore, it is preferable that the task selection optimization unit 160 optimize task selection in such a way as to satisfy constraint conditions related to worker assignment with respect to the above objective function. Specifically, the task selection optimization unit 160 preferably optimizes task selection in such a way as to satisfy: a constraint condition that restricts assigning multiple workers to one task (hereinafter referred to as a first constraint condition); a constraint condition that restricts assigning multiple tasks to one worker (hereinafter referred to as a second constraint condition); and a third constraint condition that restricts assigning a worker to a task requiring a skill not possessed by the worker (hereinafter referred to as a third constraint condition).

The first, second, and third constraint conditions may be expressed using the binary variable x_{w,wr}, as shown in Equations 2, 3, and 4 below, respectively. In Equation 4, SKILL_{wr} indicates the list of workers who possess the corresponding skill.

$$[ Math . 2 ]$$

$${\sum }_{w} ( {\sum }_{wr} {x}_{w , wr} \leq 1 ) \qquad ( Equation 2 )$$

$${\sum }_{wr} ( {\sum }_{w} {x}_{w , wr} \leq 2 ) \qquad ( Equation 3 )$$

$${\sum }_{w ∉ {Skill}_{wr}} {x}_{w , wr} = 0 \qquad ( Equation 4 )$$

As described above, the task selection optimization unit 160 may perform optimization based on the objective function and constraint conditions using a mathematical optimization solver such as linear programming, or may execute the optimization using the quantum annealing unit 180. When performing optimization using a mathematical optimization solver, objective functions and constraint conditions suited for the optimization solver are set instead of the Ising model.

The worker assignment optimization unit 170 optimizes the workers to be assigned, in consideration of constraints of the workers, for the optimized task selection. Then, the worker assignment optimization unit 170 outputs the schedule of tasks assigned to workers as a work plan. As described above, in this example embodiment, since the task selection optimization unit 160 optimizes the selection of tasks in advance, and the worker assignment optimization unit 170 only needs to specialize in optimizing the assignment of workers, the cost required for optimization can be reduced.

The objective function used in optimization by the worker assignment optimization unit 170 is also defined according to the optimization method. The following description provides an example in which optimization is performed using quantum annealing. However, as with the task selection optimization unit 160, the optimization method is not limited to quantum annealing and may instead be performed using a mathematical optimization solver.

The objective function used for optimizing worker assignment (hereinafter also referred to as the optimization model) is set based on the worker constraints considered. Examples of worker constraints include considering worker priority, balancing workload among workers, and suppressing long-distance movement in a short time.

An objective function that decreases as priority of the worker is satisfied (hereinafter referred to as a first function) may be expressed by Equation 5 below. In Equation 5, priority_{w,wr} indicates the priority of worker wr performing task w, and smaller numbers indicate higher priority.

$$[ Math . 3 ]$$

$$minimize {\sum }_{w} {\sum }_{wr} {x}_{w , wr} * {priority}_{w , wr} \qquad ( Equation 5 )$$

An objective function that decreases in value as workload is balanced among workers (hereinafter referred to as a second function) may be expressed by Equation 6 below. In Equation 6, l_{w} indicates the duration of task w.

$$[ Math . 4 ]$$

$$minimize \vert ( {\sum }_{w} {x}_{w , w r 1} * {l}_{w} ) - ( {\sum }_{w} {x}_{w , wr 2} * {l}_{w} ) \vert \qquad ( Equation 6 )$$

An objective function that decreases as suppression of long-distance movement in a short time is increased (hereinafter referred to as a third function) may be expressed by Equation 7 below. In Equation 7, distance_{w1,w2} indicates the distance between the locations of task w1 and task w2.

$$[ Math . 5 ]$$

$$minimize {\sum }_{wr} {\sum }_{w 1 , w 2} {x}_{w 1 , wr} * {x}_{w 2 , wr} * {distance}_{w 1 , w 2} \qquad ( Equation 7 )$$

The worker assignment optimization unit 170 may optimize the workers to be assigned so as to minimize an objective function that includes at least one of the above functions (first function, second function, and third function). For example, an objective function including the first, second, and third functions may be expressed by Equation 8 below. In Equation 8, w₁, w₂, and w₃ are adjusted and set by a manager or the like to produce the desired results.

$$Objective function = {w}_{1} * First Function + {w}_{2} * Second Function + {w}_{3} * Third Function \qquad ( Equation 8 )$$

The worker assignment optimization unit 170 preferably optimizes worker assignment so as to satisfy constraint conditions related to worker assignment with respect to the above objective function. The worker assignment optimization unit 170 preferably optimizes worker assignment so as to satisfy: the first and third constraint conditions described above, and a constraint condition that restricts assigning multiple tasks with overlapping time to one worker (hereinafter referred to as a fourth constraint condition).

The fourth constraint condition may be expressed by Equation 9 using the binary variable x_{w,wr}. In Equation 9, all time-overlapping tasks w1 and w2 are considered.

$$[ Math . 6 ]$$

$${\sum }_{wr} ( {\sum }_{w 1 , w 2} {x}_{w 1 , wr} + {x}_{w 2 , wr} \leq 1 ) \qquad ( Equation 9 )$$

As described above, the worker assignment optimization unit 170 may perform optimization based on the objective function and constraint conditions using a mathematical optimization solver such as linear programming, or may execute the optimization using the quantum annealing unit 180. When performing optimization using a mathematical optimization solver, objective functions and constraint conditions suited for the optimization solver are set instead of the Ising model.

The worker assignment optimization unit 170 may control the display unit 120 to display the schedule of tasks assigned to the workers (work plan). The worker assignment optimization unit 170 may also notify a message to mobile terminals (not shown) held by workers in charge of each task when the task time is approaching (e.g., 10 minutes before) to inform them of task start.

More specifically, the worker assignment optimization unit 170 may control output of additional information related to tasks, such as deadlines for executing each task and detailed information for each task.

The control unit 110, the display unit 120, the operation/input unit 130, the task selection optimization unit 160, and the worker assignment optimization unit 170 are implemented by a processor (e.g., CPU or GPU) of a computer operating according to a program (work plan optimization program).

For example, the program may be stored in a storage unit (not shown) of the work plan optimization device 100. The processor may load the program and operate as the control unit 110, the display unit 120, the operation/input unit 130, the task selection optimization unit 160, and the worker assignment optimization unit 170 according to the program. The functions of the work plan optimization device 100 may also be provided as Software as a Service (Saas).

Alternatively, the control unit 110, the display unit 120, the operation/input unit 130, the task selection optimization unit 160, and the worker assignment optimization unit 170 may be respectively implemented by dedicated hardware. Some or all of the components of each device may be implemented by general-purpose or dedicated circuitry, processors, or a combination of these. These components may be configured on a single chip or on multiple chips connected via a bus. Furthermore, some or all of the components of each device may be implemented by a combination of the aforementioned circuitry and a program.

Where some or all of the components of the work plan optimization device 100 are implemented by multiple information processing devices or circuits, these multiple devices or circuits may be centrally located or distributed. For example, the information processing devices or circuits may be connected via a communication network such as a client-server system or a cloud computing system.

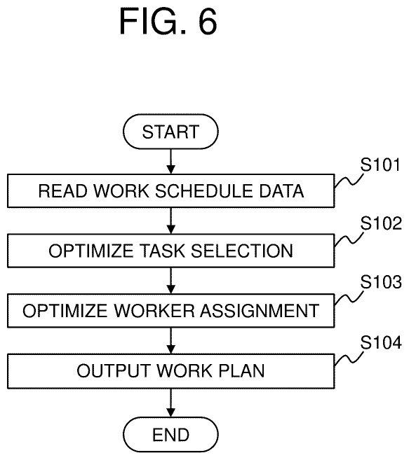

Next, the operation of the work plan optimization device 100 of this example embodiment will be described. FIG. 6 is a flowchart illustrating an example operation of the work plan optimization device 100. First, the operation/input unit 130 reads and accepts input of the work schedule data (Step S101).

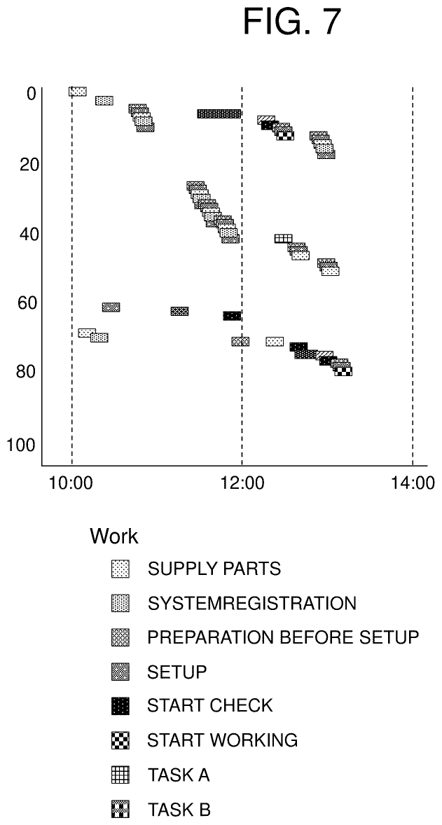

FIG. 7 is an explanatory diagram showing an example of visualized work schedule data. The example shown in FIG. 7 shows that work data (such as work content, work location, occurrence time, and work duration) scheduled to occur on all lines, work data to be performed on the day, and line information data on the day are accepted, and are visualized by changing the display mode for each task.

The task selection optimization unit 160 optimizes task selection at each time while advancing the time to assign tasks in the work processes, based on the skills and number of the workers (Step S102). More specifically, the task selection optimization unit 160 selects tasks that are feasible and minimize the loss of the objective function, based on the skills and number of the workers as well as the priority of the lines. Note that the actual assignment of workers is not performed at this stage.

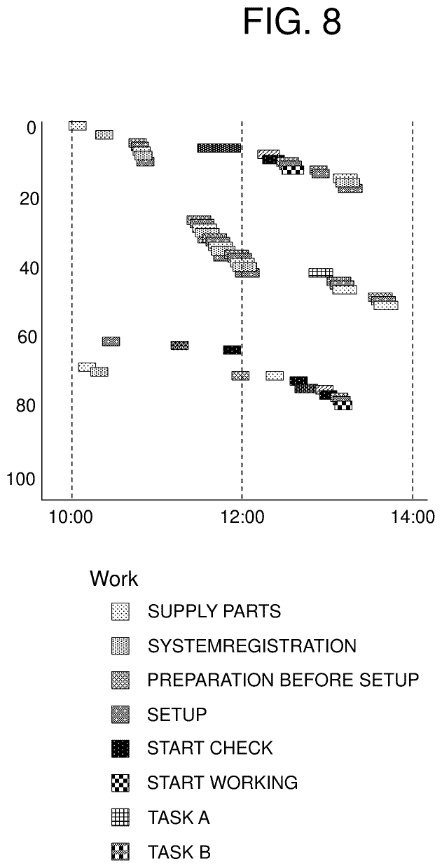

FIG. 8 is an explanatory diagram showing an example of visualized selected tasks. The example shown in FIG. 8 shows that the time to perform each task is changed as a result of optimizing the selection of tasks based on the line information data shown in FIG. 7.

The worker assignment optimization unit 170 optimizes the workers to be assigned in consideration of worker constraints for the optimized selection of tasks (Step S103). More specifically, the worker assignment optimization unit 170 optimizes the assignment of workers to all selected tasks, in consideration of worker priority, workload balancing, suppression of long-distance movement in a short time, and so on.

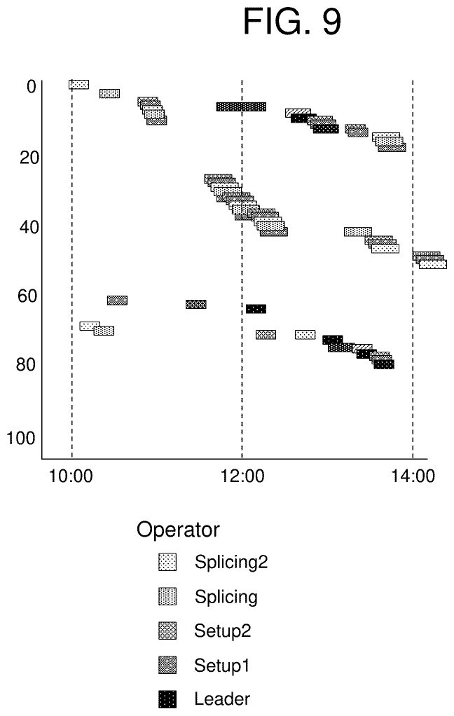

FIG. 9 is an explanatory diagram showing an example of a schedule with assigned workers. The example in FIG. 9 illustrates the visualization of worker assignments for the tasks selected in FIG. 8, with different display modes for each worker.

Then, the worker assignment optimization unit 170 outputs the schedule of tasks assigned to the workers as a work plan (work plan table) (Step S104). The worker assignment optimization unit 170 may output the work plan in a format such as a Gantt chart as illustrated in FIG. 9.

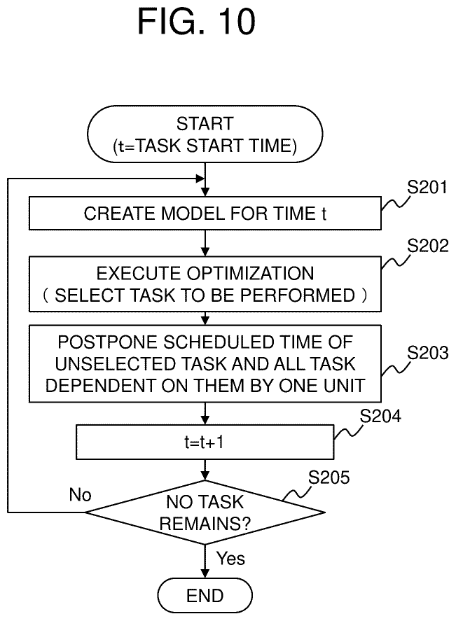

Next, the operation of the task selection optimization unit 160 of this example embodiment will be described. FIG. 10 is a flowchart illustrating an example of a task selection optimization process. The process illustrated in FIG. 10 corresponds to Step S102 in FIG. 6. Here, the optimization process is performed with the task start time being t and a predetermined interval being 1 (unit time).

First, the task selection optimization unit 160 creates an optimization model for time t (Step S201). The task selection optimization unit 160 creates an optimization model that includes the objective function shown in Equation 1 and the constraint conditions shown in Equations 2 to 4.

Next, the task selection optimization unit 160 executes the optimization process (Step S202). For example, the task selection optimization unit 160 may input the generated optimization model into the quantum annealing unit 180 to execute the optimization process.

Next, the task selection optimization unit 160 postpones the scheduled times of unselected tasks and all tasks dependent on them by one unit (Step S203), and increments t by one (Step S204).

If remaining tasks exist (No in Step S205), the processing from Step S201 onward is repeated. If no remaining tasks exist (Yes in Step S205), the task selection optimization process ends.

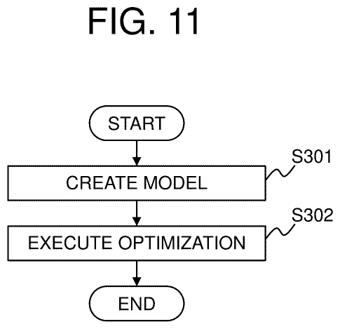

Next, the operation of the worker assignment optimization unit 170 of this example embodiment will be described. FIG. 11 is a flowchart illustrating an example of a worker assignment optimization process. The process illustrated in FIG. 11 corresponds to Step S103 in FIG. 6.

The worker assignment optimization unit 170 creates an optimization model (Step S301). For example, the worker assignment optimization unit 170 creates an optimization model including the objective function shown in Equation 8 and the constraint conditions shown in Equations 2, 4, and 9.

Then, the worker assignment optimization unit 170 executes the optimization process (Step S302). The worker assignment optimization unit 170 may input the generated optimization model into the quantum annealing unit 180 to execute the optimization process.

As described above, in this example embodiment, the task selection optimization unit 160 optimizes a selection of tasks to be prioritized at each time while advancing the time to assign tasks in the work processes, based on the skills and number of the workers. Then, the worker assignment optimization unit 170 optimizes the workers to be assigned, in consideration of constraints of the workers for the optimized selection of the tasks, and outputs the schedule of tasks assigned to the workers as a work plan. Therefore, it is possible to optimize a work plan that assigns workers in consideration of worker constraints.

In other words, in this example embodiment, by dividing work plan generation into task selection optimization to determine when tasks should start, and worker assignment optimization to determine who should perform them, it is possible to significantly reduce the time required for work plan generation. This allows multiple optimal schedules to be generated and compared for various cases with different input conditions, such as worker or line-specific loss values, thereby supporting managerial decisions.

For example, when attempting to generate a work plan simply by applying a quantum annealing method or mathematical optimization method, the model size can become very large in practical cases, making it difficult to solve within a realistic time and resulting in insufficient accuracy. For instance, in a case involving 8 lines, 30 tasks per line, a total of 600 minutes of work time, and 5 workers to assign, 720,000 variables would be required. In contrast, in this example embodiment, the problem is divided and optimized in such a way as to maintain as much overall optimality as possible, thereby making it possible to significantly reduce the time required for generating a work plan while eliminating human-dependence, waste, imbalance, and loss.

Furthermore, for example, when an unexpected task arises, a worker may perform the task without knowing its priority, which may result in an unnecessarily long line downtime and a decrease in operational efficiency. In contrast, in this example embodiment, since the time required to generate a work plan can be shortened, it is possible to suppress the decrease in operational efficiency.

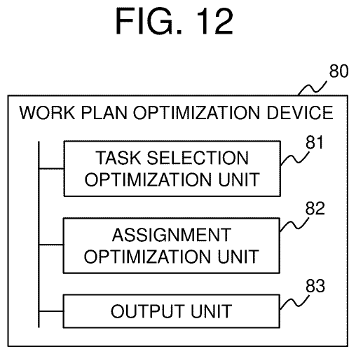

Next, an overview of the present invention will be described. FIG. 12 is a block diagram illustrating an overview of the work plan optimization device according to the present invention. A work plan optimization device 80 (e.g., the work plan optimization device 100) according to the present invention is a work plan optimization device that optimizes a plan to assign each task in a plurality of work processes (e.g., production lines) to a target worker, and includes a task selection optimization unit 81 (e.g., the task selection optimization unit 160) that optimizes, while advancing time to assign tasks in the work processes, a selection of tasks to be prioritized at each time based on skills and number of the workers, an assignment optimization unit 82 (e.g., the worker assignment optimization unit 170) that optimizes the workers to be assigned, in consideration of constraints of the workers, for the optimized selection of the tasks, and an output unit 83 (e.g., the worker assignment optimization unit 170) that outputs a schedule of tasks assigned to the workers as a work plan.

With such a configuration, it is possible to optimize a work plan that assigns workers in consideration of worker constraints.

The assignment optimization unit 82 may optimize the workers to be assigned in such a way as to minimize an objective function (e.g., Equation 8) including at least one of: a first function (e.g., Equation 5) that decreases as priority of the worker is satisfied, a second function (e.g., Equation 6) that decreases as workload is balanced among the workers, and a third function (e.g., Equation 7) that decreases as suppression of long-distance movement in a short time is increased.

The task selection optimization unit 81 may optimize the selection of tasks in such a way as to satisfy a first constraint condition (e.g., Equation 2) that restricts assigning multiple workers to one task, a second constraint condition (e.g., Equation 3) that restricts assigning multiple tasks to one worker, and a third constraint condition (e.g., Equation 4) that restricts assigning a worker to a task requiring a skill not possessed by the worker.

The task selection optimization unit 81 may optimize the selection of tasks based on a priority of the work processes (e.g., Equation 1).

Either or both of the task selection optimization unit 81 and the assignment optimization unit 82 may execute optimization (e.g., pseudo quantum annealing, quantum-inspired, etc.) using a quantum annealing machine (e.g., quantum annealing unit 180).

Some or all of the above-described example embodiments may also be expressed as the following Supplementary Notes, which are not limited thereto.

(Supplementary Note 1) A work plan optimization device that optimizes a plan to assign each task in a plurality of work processes to a target worker, the work plan optimization device comprising:
a task selection optimization unit that optimizes, while advancing time to assign tasks in the work processes, a selection of tasks to be prioritized at each time based on skills and number of the workers;
an assignment optimization unit that optimizes the workers to be assigned, in consideration of constraints of the workers, for the optimized selection of the tasks; and
an output unit that outputs a schedule of tasks assigned to the workers as a work plan.

(Supplementary Note 2) The work plan optimization device according to Supplementary Note 1, wherein
the assignment optimization unit optimizes the workers to be assigned in such a way as to minimize an objective function including at least one of: a first function that decreases as priority of the worker is satisfied, a second function that decreases as workload is balanced among the workers, and a third function that decreases as suppression of long-distance movement in a short time is increased.

(Supplementary Note 3) The work plan optimization device according to Supplementary Note 2, wherein
the assignment optimization unit optimizes the workers to be assigned in such a way as to satisfy a constraint condition that restricts assigning multiple tasks with overlapping time to one worker.

(Supplementary Note 4) The work plan optimization device according to Supplementary Note 2 or 3, wherein
the priority of a worker is preset based on at least one of a worker's strengths or weaknesses for specific tasks and other duties.

(Supplementary Note 5) The work plan optimization device according to any one of Supplementary Notes 1 to 4, wherein
the task selection optimization unit optimizes the selection of tasks in such a way as to satisfy a first constraint condition that restricts assigning multiple workers to one task, a second constraint condition that restricts assigning multiple tasks to one worker, and a third constraint condition that restricts assigning a worker to a task requiring a skill not possessed by the worker.

(Supplementary Note 6) The work plan optimization device according to any one of Supplementary Notes 1 to 5, wherein
the task selection optimization unit optimizes the selection of tasks based on a priority of the work processes.

(Supplementary Note 7) The work plan optimization device according to any one of Supplementary Notes 1 to 6, wherein
the task selection optimization unit optimizes the selection of tasks to be prioritized at each time, based on skills and the number of the workers, while advancing the time to assign tasks in the work processes at predetermined intervals.

(Supplementary Note 8) The work plan optimization device according to any one of Supplementary Notes 1 to 7, wherein
the task selection optimization unit selects tasks in such a way as to minimize an objective function that represents a total loss generated when each worker does not perform each task.

(Supplementary Note 9) The work plan optimization device according to Supplementary Note 8, wherein
the task selection optimization unit selects tasks that are feasible and minimize the loss of the objective function based on the skills and number of the workers and a priority of lines.

(Supplementary Note 10) The work plan optimization device according to any one of Supplementary Notes 1 to 9, wherein
either or both of the task selection optimization unit and the assignment optimization unit execute optimization using a quantum annealing machine.

(Supplementary Note 11) The work plan optimization device according to any one of Supplementary Notes 1 to 10, wherein
the assignment optimization unit controls a display unit to display assignment of workers.

(Supplementary Note 12) The work plan optimization device according to Supplementary Note 11, wherein
the assignment optimization unit controls the display to show the assignment of workers in a Gantt chart format.

(Supplementary Note 13) The work plan optimization device according to Supplementary Note 11 or 12, wherein
the assignment optimization unit controls the display to change a display mode for each task.

(Supplementary Note 14) The work plan optimization device according to any one of Supplementary Notes 1 to 13, wherein
the assignment optimization unit controls, based on assignment of the workers, a notification of a message to mobile terminals held by the workers in charge of each task to inform the start of the task a predetermined time before task time.

(Supplementary Note 15) The work plan optimization device according to any one of claims 1 to 14, wherein
the assignment optimization unit controls output to mobile terminals held by workers in charge of each task of a deadline for executing each task as information associated with the assigned task.

(Supplementary Note 16) The work plan optimization device according to any one of Supplementary Notes 1 to 15, wherein
the assignment optimization unit controls output to mobile terminals held by workers in charge of each task of detailed information of each task as information associated with the assigned task.

(Supplementary Note 17) A work plan optimization method that optimizes a plan to assign each task in a plurality of work processes to a target worker, the work plan optimization method comprising:
optimizing, while advancing time to assign tasks in the work processes, a selection of tasks to be prioritized at each time based on the skills and number of the workers;
optimizing the workers to be assigned in consideration of constraints of the workers for the optimized selection of the tasks; and
outputting a schedule of tasks assigned to the workers as a work plan.

(Supplementary Note 18) The work plan optimization method according to Supplementary Note 17, wherein
the workers to be assigned are optimized in such a way as to minimize an objective function including at least one of: a first function that decreases as priority of the worker is satisfied, a second function that decreases as workload is balanced among the workers, and a third function that decreases as suppression of long-distance movement in a short time is increased.

(Supplementary Note 19) A work plan optimization program applied to a computer that optimizes a plan to assign each task in a plurality of work processes to a target worker, a program storage medium storing the program causing the computer to execute:
a task schedule optimization process that optimizes a selection of tasks to be prioritized at each time based on skills and number of the workers while advancing time to assign tasks in the work processes;
an assignment optimization process that optimizes the workers to be assigned in consideration of constraints of the workers for the optimized selection of the tasks; and
an output process that outputs a schedule of tasks assigned to the workers as a work plan.

(Supplementary Note 20) The program storage medium according to Supplementary Note 19, storing the work plan optimization program that causes the computer to optimize the workers to be assigned in such a way as to minimize an objective function including at least one of: a first function that decreases as priority of the worker is satisfied, a second function that decreases as workload is balanced among the workers, and a third function that decreases as suppression of long-distance movement in a short time is increased.

(Supplementary Note 21) A work plan optimization program applied to a computer that optimizes a plan to assign each task in a plurality of work processes to a target worker, the program causing the computer to execute:
a task schedule optimization process that optimizes a selection of tasks to be prioritized at each time based on skills and number of the workers while advancing time to assign tasks in the work processes;
an assignment optimization process that optimizes the workers to be assigned in consideration of constraints of the workers for the optimized selection of the tasks; and
an output process that outputs a schedule of tasks assigned to the workers as a work plan.

(Supplementary Note 22) The work plan optimization program according to Supplementary Note 21, the program causing the computer to optimize the workers to be assigned in such a way as to minimize an objective function including at least one of: a first function that decreases as priority of the worker is satisfied, a second function that decreases as workload is balanced among the workers, and a third function that decreases as suppression of long-distance movement in a short time is increased.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

This application is based upon and claims the benefit of priority from Japanese patent application No. 2023-21319, filed on Feb. 15, 2023, the disclosure of which is incorporated herein in its entirety by reference.

### INDUSTRIAL APPLICABILITY

The present invention is suitably applicable to a work plan optimization device that optimizes a work plan that assigns workers to tasks in a plurality of work processes. For example, the invention can be applied in factories with multiple lines where manual tasks occur simultaneously.

### REFERENCE SIGNS LIST

100 Work plan optimization device
110 Control unit
120 Display unit
130 Operation/input unit
140 Worker database
150 Work location distance database
160 Task selection optimization unit
170 Worker assignment optimization unit
180 Quantum annealing unit

What is claimed is:

1. A work plan optimization device that optimizes a plan to assign each task in a plurality of work processes to a target worker, the work plan optimization device comprising:
a memory storing instructions; and
one or more processors configured to execute the instructions to:
optimize, while advancing time to assign tasks in the work processes, a selection of tasks to be prioritized at each time based on skills and number of the workers;
optimize the workers to be assigned, in consideration of constraints of the workers, for the optimized selection of the tasks; and
output a schedule of tasks assigned to the workers as a work plan.

2. The work plan optimization device according to claim 1, wherein the processor is configured to execute the instructions to optimize the workers to be assigned in such a way as to minimize an objective function including at least one of: a first function that decreases as priority of the worker is satisfied, a second function that decreases as workload is balanced among the workers, and a third function that decreases as suppression of long-distance movement in a short time is increased.

3. The work plan optimization device according to claim 2, wherein the processor is configured to execute the instructions to optimize the workers to be assigned in such a way as to satisfy a constraint condition that restricts assigning multiple tasks with overlapping time to one worker.

4. The work plan optimization device according to claim 2, wherein
the priority of a worker is preset based on at least one of a worker's strengths or weaknesses for specific tasks and other duties.

5. The work plan optimization device according to claim 1, wherein the processor is configured to execute the instructions to optimize the selection of tasks in such a way as to satisfy a first constraint condition that restricts assigning multiple workers to one task, a second constraint condition that restricts assigning multiple tasks to one worker, and a third constraint condition that restricts assigning a worker to a task requiring a skill not possessed by the worker.

6. The work plan optimization device according to claim 1, wherein the processor is configured to execute the instructions to optimize the selection of tasks based on a priority of the work processes.

7. The work plan optimization device according to claim 1, wherein the processor is configured to execute the instructions to optimize the selection of tasks to be prioritized at each time, based on skills and the number of the workers, while advancing the time to assign tasks in the work processes at predetermined intervals.

8. The work plan optimization device according to claim 1, wherein the processor is configured to execute the instructions to select tasks in such a way as to minimize an objective function that represents a total loss generated when each worker does not perform each task.

9. The work plan optimization device according to claim 8, wherein the processor is configured to execute the instructions to select tasks that are feasible and minimize the loss of the objective function based on the skills and number of the workers and a priority of lines.

10. The work plan optimization device according to claim 1, wherein the processor is configured to execute the instructions to execute optimization using a quantum annealing machine; and
wherein the quantum annealing machine is a dedicated machine that is communicably connected to the work plan optimization device.

11. The work plan optimization device according to claim 1, wherein the processor is configured to execute the instructions to control a display unit to display assignment of workers.

12. The work plan optimization device according to claim 11, wherein the processor is configured to execute the instructions to control the display to show the assignment of workers in a Gantt chart format.

13. The work plan optimization device according to claim 11, wherein the processor is configured to execute the instructions to control the display to change a display mode for each task.

14. The work plan optimization device according to claim 1, wherein the processor is configured to execute the instructions to control, based on assignment of the workers, a notification of a message to mobile terminals held by the workers in charge of each task to inform the start of the task a predetermined time before task time.

15. The work plan optimization device according to claim 1, wherein the processor is configured to execute the instructions to control output to mobile terminals held by workers in charge of each task of a deadline for executing each task as information associated with the assigned task.

16. The work plan optimization device according to claim 1, wherein the processor is configured to execute the instructions to control output to mobile terminals held by workers in charge of each task of detailed information of each task as information associated with the assigned task.

17. A work plan optimization method that optimizes a plan to assign each task in a plurality of work processes to a target worker, the work plan optimization method comprising:
optimizing, while advancing time to assign tasks in the work processes, a selection of tasks to be prioritized at each time based on the skills and number of the workers;
optimizing the workers to be assigned in consideration of constraints of the workers for the optimized selection of the tasks; and
outputting a schedule of tasks assigned to the workers as a work plan.

18. The work plan optimization method according to claim 17, wherein
the workers to be assigned are optimized in such a way as to minimize an objective function including at least one of: a first function that decreases as priority of the worker is satisfied, a second function that decreases as workload is balanced among the workers, and a third function that decreases as suppression of long-distance movement in a short time is increased.

19. A non-transitory computer readable information recording medium storing a work plan optimization program applied to a computer that optimizes a plan to assign each task in a plurality of work processes to a target worker, when executed by a processor, the work plan optimization program performs a method for:
a task schedule optimization process that optimizes a selection of tasks to be prioritized at each time based on skills and number of the workers while advancing time to assign tasks in the work processes;
an assignment optimization process that optimizes the workers to be assigned in consideration of constraints of the workers for the optimized selection of the tasks; and
an output process that outputs a schedule of tasks assigned to the workers as a work plan.

20. The non-transitory computer readable information recording medium according to claim 19, storing the work plan optimization program that causes the computer to optimize the workers to be assigned in such a way as to minimize an objective function including at least one of: a first function that decreases as priority of the worker is satisfied, a second function that decreases as workload is balanced among the workers, and a third function that decreases as suppression of long-distance movement in a short time is increased.
